(19) United States
(12) Patent Application Publication
(10) Pub. No.: US 2004/0070224 A1
(43) Pub. Date: Apr. 15, 2004

(54) Hand-held magnetic coin-retrieval tool

(76) Inventor: John J. Nurmi, Sudbury (CA)

Correspondence Address: Mike M. Gauthier, 1264156 Ontario Incorporated, o/a Intel-Pro Design and Mfg., 959 Elisabella Street, Unit C, Sudbury, ON, P3A 5K1, CA

(21) Appl. No.: 10/268,748

(22) Filed: Oct. 11, 2002

(51) Int. Cl. B25J 15/06

(52) U.S. Cl. 294/65.5

(57) ABSTRACT

In a hand-held magnetic device for retrieving metallic coins, the device of the present invention comprises; a magnet holding portion fixedly and integrally attached to a handle portion wherein the magnet holding portion is generally disk-shaped and adapted with a hollow magnet holding portion in its underside, a planar upper surface having a slightly raised edge around its perimeter whereby an advertising label may be affixed to said planar surface, a perforation through the end of the handle distal to the magnet holding portion is provided to allow the suspension of the device by means of a wall hook or a neck-string or the like, a removable belt clip adapted to releasably attach to a rectangular opening through the handle having a pair of resilient tabs which come closer together when inserted through the rectangular opening of the handle until such a time that the tabs traverse the opposite edge of the opening, the tabs then separate from each other to be releasably locked in a firm position, then the user can pinch the two tabs together to allow egress for the tabs and release the clip from the handle.

FIELD OF THE INVENTION The present invention relates to a hand-held magnetic device for retrieving metallic coins. The device of the present invention comprises; a magnet holding portion fixedly and integrally attached to a handle portion wherein the magnet holding portion is generally disk-shaped and adapted with a hollow magnet holding portion in its underside, a planar upper surface having a slightly raised edge around its perimeter whereby an advertising label may be affixed to said planar surface, a perforation through the end of the handle distal to the magnet holding portion is provided to allow the suspension of the device by means of a wall hook and a neck-string or the like, a removable belt clip adapted to releasably attach to a rectangular opening through the handle having a pair of resilient tabs which come closer together when inserted through the rectangular opening of the handle until such a time that the tabs traverse the opposite edge of the opening, the tabs then separate from each other to be releasably locked in a firm position, then the user can pinch the two tabs together to allow egress for the tabs and release the clip from the handle.

### BACKGROUND OF THE INVENTION

The restaurant and bar industry waiters are often additionally compensated for good service by means of a tip whereby a customer would leave loose change on the table or bar for the waiter. Although this is a kind gesture on the part of the customer, this loose change is sometimes difficult to gather and retrieve since especially bar countertops have a raised edge or lip to prevent fluids from spilling on the floor surface. Coins often need to be retrieved one by one.

The inventor sought to provide waiters and bartenders with a device that would easily retrieve hard to gather metallic coins left by customers. The device would have to be strong enough to take the abuse of day-to-day wear present is the industry, and would have to be easily washable. Additionally, the device would have to be suspendable from a neck string or by a hook to a wall surface. Furthermore, it would have to be adapted to clip on a waist belt for those users who prefer this.

It is therefore desirable for waiters and bartenders alike to have available a device that would easily retrieve hard to gather metallic coins left by customers.

The applicant is aware of several attempts in prior art to provide means of magnetically retrieving metallic objects.

An example may be had when referring to U.S. Pat. No. 3,582,123 of Kyser, issued Jun. 1, 1971 depicting a magnetic retrieving tool wherein a magnetic end tool is hinged to a handle member so as to provide adjustability to the magnet. For coins, the device fails to provide a large magnet area where many coins could be attracted. Additionally, the tool is not particularly easily portable on oneself other than carrying it in one hand.

Another example may be had in referring to U.S. Pat. No. 3,789,336 of Gordin, issued Jan. 29, 1974, which teaches of a retractable magnet holder wherein a cylindrical pen-like tool is used to contain and eject a magnetic tool for the purpose of retrieving small metallic objects. This invention would fail to pick up a plurality of coins since the magnet size would hinder on the magnetic strength.

Another example may be had in referring to U.S. Pat. No. 4,105,239 of Akczinski, issued Aug. 8, 1978, which teaches of a magnetic tool designed to assist the handicapped in picking up metallic objects which are at a substantial distance from the user. The handle extends to allow adjustability of extension. However, the tool fails to be portable and to be secured to the user for convenient accessibility.

### SUMMARY OF THE INVENTION

It is thus the object of the present invention to provide waiters and bartenders with a device that easily retrieves hard to gather metallic coins left by customers. A device that is strong enough to take the abuse of day-to-day wear present is the industry, and easily washable. The device is easily suspendable from a neck string or by a hook to a wall surface. It can be clipped on a waist belt for those users who prefer this.

In one aspect of the invention, the tool of the present invention may be fabricated of various suitable materials.

In another aspect of the invention, the belt clip may be integrally molded with the handle.

In another aspect of the invention, a coin releasing attachment may be provided for easier release of coins from the magnet.

In yet another aspect of the invention, the magnet may be an electromagnet so as to automatically release said coins.

Accordingly, the tool of the present invention provides waiters and bartenders with a device that easily retrieves hard to gather metallic coins left by customers. A device that is strong enough to take the abuse of day-to-day wear present is the industry, and easily washable. A device that is easily suspendable from a neck string, a waist belt or by a hook to a wall surface.

The utility of this hand-held magnetic coin-retrieving tool includes but is not limited to coins.

### BRIEF DESCRIPTION OF THE DRAWINGS

These and other advantages of the invention will become apparent upon reading the following brief description and upon referring to the drawings in which:-

FIG. 1 is a perspective view from above of the hand-held magnetic coin-retrieving tool of the present invention.

FIG. 2 is a perspective view from below of the hand-held magnetic coin-retrieving tool of the present invention.

FIG. 3 is a top plan view of the hand-held magnetic coin-retrieving tool of the present invention.

FIG. 4 is a bottom plan view of the hand-held magnetic coin-retrieving tool of the present invention.

FIG. 5 is a right side elevation view of the hand-held magnetic coin-retrieving tool of the present invention.

FIG. 6 is a front elevation view of the hand-held magnetic coin-retrieving tool of the present invention.

FIG. 7 is a rear elevation view of the hand-held magnetic coin-retrieving tool of the present invention.

FIG. 8 is a cross-sectional view of FIG. 3 illustrating the releasable attachment of a clip to the handle of the hand-held magnet coin-retrieving tool of the present invention.

While the invention is described in conjunction with preferred illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

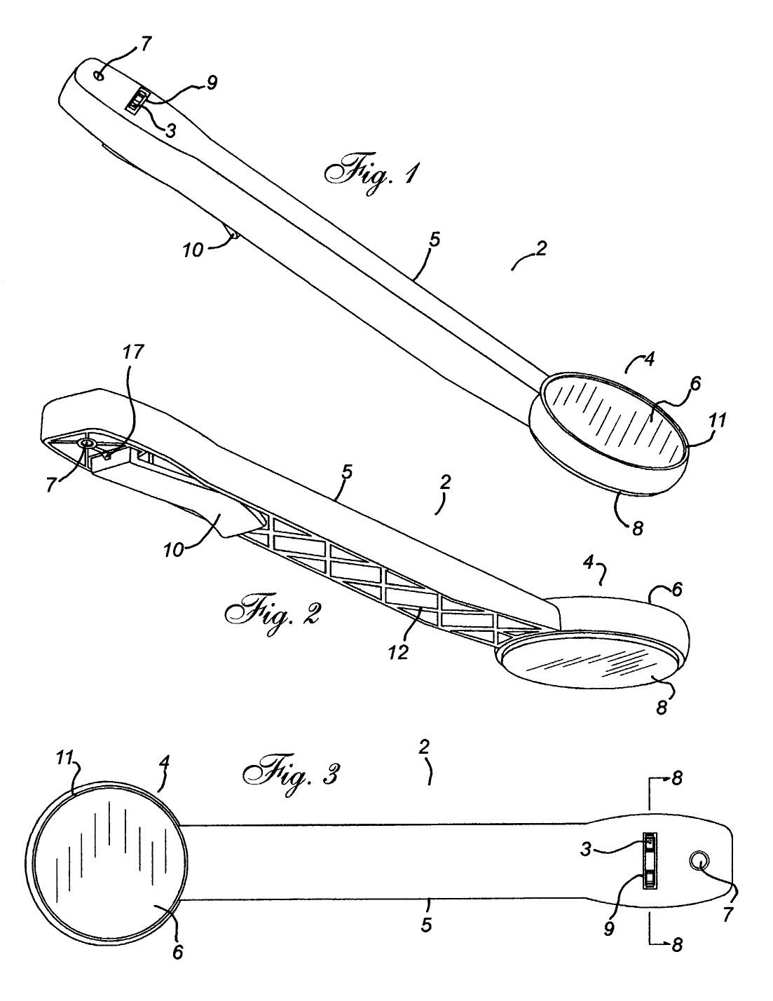

Turning to the drawings, in particular, FIG. 1, which illustrates a perspective view from above of the hand-held magnetic coin-retrieving tool 2 of the present invention wherein the tool 2 comprises; a disk-like magnet holding portion 4 having a slightly rounded perimeter, a lower portion adapted with a opened end so as to provide an opening in which a magnet 8 may be engaged, an upper portion having a slightly recessed surface 6 with an outside diameter slightly lesser that that of the outer diameter of the disk-like magnet holding portion 4 providing a raised edge 11 so as to enable the fixation of an advertising label to the planar area of the recess 6 where said raised edge 11 may prevent the label from being easily removed, a disk-shaped magnet 8 having an outside diameter equal to that of the inside diameter of the opening of the disk-like magnet holding portion 4, a handle 5 integrally and angularly attached with an outer edge of the disk-like magnet holding portion 4, a perforation 7 through the handle 5 at the end distal to the magnet holding portion 4 so as to provide means of suspending the tool from a neck string or by a hook to a wall surface, a removable belt clip 10 adapted to snap within an opening 9 in the handle 5 distal to the magnet portion 4.

Turning now to FIG. 2, a perspective view from below of the hand-held magnetic coin-retrieval tool 2 of the present invention illustrating the reinforcing ribs 12 integrally incorporated within the handle portion 5 so as to provide structural strength to the handle 5. In this figure, also illustrating the position of the belt clip 10 wherein the upper portion of the clip 10 traverses an opening 9 in the region of the handle 5 distal to the magnet-holding portion 4. The belt clip 10 is adapted with a positive stop 17 which serves to limit the depth which the clip 10 traverses though the opening 9. The magnet 8 is frictionally engaged within an opening in the magnet-holding portion 4 as well as fixedly attached to the inner surface of said magnet-holding portion 4 by means of a water resistant adhesive.

In reference now to FIG. 3, a top plan view of the hand-held magnetic coin-retrieval tool 2 of the present invention illustrating the positioning of the perforation 7 and the opening 9 in which the clip 10 snaps in place. Additionally, the figure further illustrates the ergonomic features incorporated within the handle portion 5 distal to the magnet-holding portion 4 wherein this ergonomicy promotes comfort to the user.

Referring now to FIG. 4, a bottom plan view of the hand-held magnetic coin-retrieval tool 2 of the present invention illustrating the reinforcing ribs 12 integrally incorporated within the handle portion 5 so as to provide structural strength to the handle 5. This figure also illustrates the position of the belt clip 10 wherein the upper portion of the clip 10 traverses an opening 9 in the region of the handle 5 distal to the magnet-holding portion 4. The belt clip 10 is adapted with a positive stop 17 which serves to limit the depth which the clip 10 traverses though the opening 9. The magnet 8 is frictionally engaged within an opening in the magnet-holding portion 4 as well as fixedly attached to the inner surface of said magnet-holding portion 4 by means of a water resistant adhesive.

In reference now to FIG. 5, a right-side elevation view of the hand-held magnetic coin-retrieving tool 2 of the present invention wherein an angle between the magnet-holding portion 4 and the handle 5 is provided to ensure that the lower planar surface of the magnet 8 remains adjacent in relation to the surface on which coins are retrieved while keeping the user's fingers slightly distal from said surface.

FIG. 6, a front elevation view of the hand-held magnetic coin-retrieving tool 2 of the present invention serves as an illustration only.

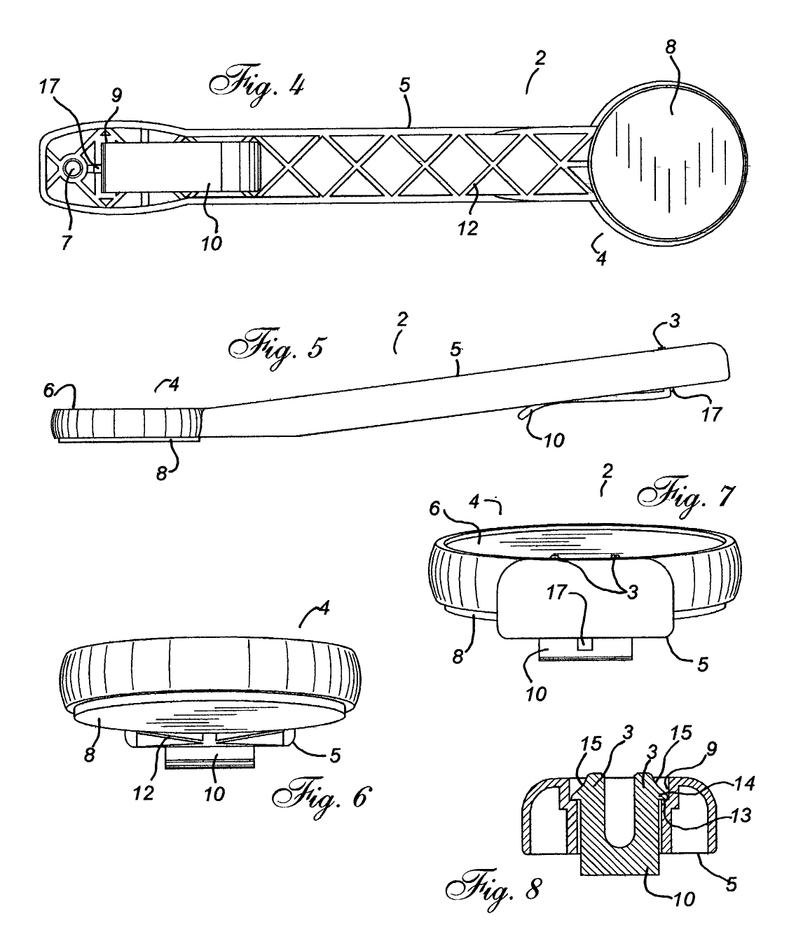

FIG. 7, a rear elevation view of the hand-held magnetic coin-retrieving tool 2 of the present invention serves as an illustration only.

In reference now to FIG. 8, a cross-sectional view from FIG. 3 depicting the preferred assembly of the belt clip 10 within the opening 9 in the handle 5 wherein by inserting the tabs 3 at the upper portion of the belt clip 10, said tabs 3 are displaced proximally to each other thereby allowing the tab locks 14 which have a greater width apart than that of the opening 9 within the handle 5 so that when the tabs 3 are firmly pushed up in place, the material resilience of the clip 10 and tabs 3 allow the tabs 3 to return to their resting position in relation to the belt clip 10. Once the belt clip 10 is firmly placed in the opening, the tab locks 14 snap outwardly to rest atop the recessed shoulders 13 of the opening 9. Removal of the belt clip 10 is accomplished by simply depressing the tabs 3 inwardly with a finger and opposing thumb on the curved area 15 of the tabs 3 until the tabs locks 14 slip off the shoulder 13 of the opening 9 within the handle 5 thereby releasing the belt clip 10.

What I claim as my invention:

1. A hand-held coin-retrieval tool comprising:
a. a disk-like magnet holding portion having a slightly rounded perimeter, a lower portion adapted with a opened end so as to provide an opening in which a magnet may be engaged, an upper portion having a slightly recessed surface with an outside diameter slightly lesser that that of the outer diameter of the disk-like magnet holding portion providing a raised edge so as to enable the fixation of an advertising label to the planar area of the recess where said raised edge may prevent the label from being easily removed,
b. a disk-shaped magnet having an outside diameter equal to that of the inside diameter of the opening of the disk-like magnet holding portion,
c. a handle integrally and angularly attached with an outer edge of the disk-like magnet holding portion, a perforation at the end distal to the magnet holding portion so as to provide means of suspending the tool from a neck string or by a hook to a wall surface.
d. a removable belt clip adapted to snap within an opening in the handle distal to the magnet holding portion,

2. The handle and magnet holding portions of claim 1 wherein both portions may be molded from a thermo resin material.

3. The magnet of claim 1 wherein said magnet is of sufficient strength to magnetically attract a plurality of metallic coins.

4. The handle of claim 1 wherein reinforcing ribs are provided below the top surface and between two sides of said handle so as to help the handle remain rigid.

5. The hand-held magnetic coin-retrieval tool of claim 1 wherein the handle portion is slightly angled upwardly in relation to the magnet-holding portion.

6. The belt clip of claim 1 wherein said belt clip is releasably attached to the handle so as to give the user the option to use the clip of not.
